(19) United States
(12) Patent Application Publication
(10) Pub. No.: US 2024/0069196 A1
(43) Pub. Date: Feb. 29, 2024

(54) Systems and Methods for Time of Flight Measurement Implementing Threshold-Based Sampling for Waveform Digitizing

(71) Applicant: Hong Kong Applied Science and Technology Research Institute Co., Ltd., Shatin (HK)

(72) Inventors: Weiwen Yu, Tai Po (HK); Ka Sing Anthony Yuen, Sha Tin (HK)

(21) Appl. No.: 17/898,956

(22) Filed: Aug. 30, 2022

(51) Int. Cl. G01S 17/10; G01S 7/481; G01S 7/4865

(52) U.S. Cl. CPC G01S 17/10; G01S 7/4817; G01S 7/4865

(57) ABSTRACT

Systems and methods which provide time of flight (ToF) measurement techniques implementing threshold-based sampling for waveform digitizing to generate a signal waveform representing a detected ToF measurement signal from which a ToF distance measurement is determinable are described. An example ToF measurement system may apply one or more curve fitting techniques, such as using one or more curve fitting hardware accelerators, to data from threshold-based sampling for waveform digitizing of the received pulse. Examples of a ToF measurement system may implement time-to-digital converters (TDCs) to sample a received pulse using a plurality of thresholds. ToF measurement systems of examples may implement multi-point filtering, such as using a hardware accelerator.

### TECHNICAL FIELD

The present invention relates generally to time of flight (ToF) measurement and, more specifically, to techniques for ToF measurement implementing threshold-based sampling for waveform digitizing. Some features may enable and provide improved ToF measurement sample processing using hardware acceleration with respect to waveform reconstruction.

### BACKGROUND OF THE INVENTION

Time of flight (ToF) measurement is a technique by which a distance is measured based on the time taken by an object, particle, or wave (e.g., acoustic, electromagnetic, etc.) to travel a distance to/from a target of the ToF distance measurement. For example, a ToF measurement system may measure distances using the time that it takes for photons to travel between two points, such as from the ToF measurement system emitter to a target and then back to the ToF measurement system receiver (also referred to herein as a detector or sensor). In operation according to a laser ToF distance measurement system, a distance may be measured by illuminating a target with laser light, receiving the reflection of the laser light with a sensor, and computing the distance as a function of the time from the transmission of the laser light to receiving the reflection of the laser light (e.g., d=(ct)/2, where d is the distance, c is the speed of light, and t is the time from the transmission of the laser light to receiving the reflection of the laser light).

Indirect and direct ToF techniques have been utilized for ToF measurements. Both techniques may be utilized to simultaneously measure intensity and distance for each pixel in a scene.

In operation according to an example of an indirect ToF measurement systems (see e.g., U.S. Pat. No. 9,347,773B2 the disclosure of which is incorporated herein by reference), the ToF measurement system emitter emits continuous, modulated (e.g., power/amplitude modulated) laser light and utilizes a phase detector to measure the phase difference of detected reflected light to indicate a ToF for calculation of the distance to a target. Indirect ToF measurement systems provide relatively high precision distance measurement within an effective range of the system and have been widely utilized. Thus, integrated circuits for various implementation of indirect ToF measurement systems are well developed, and such indirect ToF measurement systems may generally be provided at relatively low cost. Indirect ToF measurement systems are not, however, without disadvantage. For example, the continuous emission of modulated laser light for the ToF measurement places power limitations on the indirect ToF measurement systems. Relatively low power laser emission, and thus reduced distance measurement range, may be required in order to maintain class one laser emissions and/or manage power consumption by the system. Further, because the distance determination relies upon detection of a phase shift (e.g., Δθ), where the distance to be measured is so long as to result in the phase shift exceeding the modulation frequency (e.g., Δθ>2π). Constraints with respect to distance measurement range of indirect ToF measurement systems are necessary to avoid phase ambiguity with respect to the distance measurement.

In operation according to an example of direct ToF measurement systems (see e.g., U.S. Pat. No. 9,529,085B2 and CN109459757A, the disclosures of which are incorporated herein by reference), the ToF measurement system emitter emits short pulses of light (e.g., lasting a few nanoseconds) and utilizes a detector to measure the time it takes for reflected light to be detected to indicate a ToF for calculation of the distance to a target. In particular, the ToF measurement system emitter emits pulsed laser light and utilizes a time-to-digital converter (TDC) to detect a selected feature of detected reflected light (e.g., a point at which an amplitude of the reflected signal crosses a detection threshold), wherein the distance to a target is calculated from comparing the selected feature of the emitted pulse and selected feature of the digitized waveform to indicate a ToF for calculation of the distance to a target. Using the pulsed laser light of direct ToF measurement systems, high peak power can be achieved, enabling long range measurement. However, such direct ToF measurement systems often provide relatively low precision. Differences in the reflectivity of the target may, for example, result in an error (referred to as “walk error”) resulting from variance from sample to sample in the time at which an amplitude of the detected reflected light crosses the detection threshold relative to the corresponding feature of the emitted pulse of laser light. Walk errors introduce corresponding errors in the ToF calculation, and thus the distance measurement.

A waveform digitizing (WFD) direct ToF measurement technique may be utilized to avoid or mitigate walk error. In operation according to an example of WFD direct ToF measurement systems (see e.g., US2013/0107000A1 and U.S. Pat. No. 9,347,773B2, the disclosures of which are incorporated herein by reference) detected reflected light is digitized to provide a pulse shape waveform from which ToF for calculation of the distance to a target is determined. In particular, the ToF measurement system emitter emits pulsed laser light and utilizes a high sampling rate resolution analog-to-digital converter (ADC) (e.g., sampling rate in the range of 100 MS/s to 6 GS/s) to digitize the waveform of detected reflected light, wherein the distance to a target is calculated from comparison of the emitted pulse and the digitized waveform (e.g., waveform peak to peak comparison) to indicate a ToF for calculation of the distance to a target. As with the direct ToF measurement technique described above, the WFD direct ToF measurement technique enables long range measurement. Moreover, the full information of the pulse shape provided according to the WFD direct ToF measurement technique provides relatively high precision. However, generation of the pulse shape for facilitating relatively high precision ToF measurement according to existing WFD direct ToF measurement systems requires a high speed sample digitizing circuit reconstruction algorithm, which results in a complicated system and high cost.

### BRIEF SUMMARY OF THE INVENTION

The present invention is directed to systems and methods which provide time of flight (ToF) measurement techniques implementing threshold-based sampling for waveform digitizing to generate a signal waveform representing a detected ToF measurement signal from which a ToF distance measurement is determinable. For example, a ToF measurement system of embodiments of the present invention may operate to sample a received pulse (e.g., a detected ToF measurement signal as reflected by a target for which distance is being measured) and output digital ToF signal sample data for a plurality of threshold-based samples of received pulse. Thereafter, the ToF measurement system may apply one or more curve fitting techniques to the digital ToF signal sample data for waveform digitizing of the received pulse. For example, a curve fitting technique (e.g., implementing linear curve fitting or non-linear curve fitting) may be implemented according to examples of a ToF measurement system to generate a signal waveform representing a detected ToF measurement signal (e.g., ToF measurement laser pulse reflected from a target) from which a ToF distance measurement is determinable (e.g., a distance to the target is determined from a magnitude of the roundtrip time of the ToF measurement signal from an emitter to the detector).

Example ToF measurement systems may implement (e.g., as part of a sampling circuit configured to detect ToF measurement signals) one or more time-to-digital converters (TDCs) to sample a received pulse (e.g., a detected ToF measurement signal as reflected by a target for which distance is being measured). For example, a plurality of thresholds may be utilized with one or more TDCs (e.g., a TDC may be implemented for each threshold of the plurality of thresholds) to implement threshold-based sampling in which times at which a detected ToF measurement signal crosses each of the plurality of thresholds provides digital ToF signal sample data output (e.g., time of threshold crossing). According to examples herein, the plurality of thresholds may comprise voltage thresholds, such as may provide a same voltage threshold for both the rising and falling edges of a detected ToF measurement signal, wherein the digital ToF signal sample data may comprise time data with respect to the detected ToF measurement signal crossing each voltage threshold of the plurality of thresholds.

TDCs implemented according to embodiments of the present invention provide high time resolution sampling, particularly when sampling narrow pulse, as well as providing high accuracy and low cost, as well as facilitating high processing throughput. In particular, TDCs implemented according to concepts herein facilitate higher time resolution than an analog-to-digital (ADC) implementation of similar cost. The digital ToF signal sample data provided by TDCs implementing threshold-based sampling according to concepts herein, however, do not provide for a fixed sampling frequency. Accordingly, embodiments of the invention implement further processing with respect to the digital ToF signal sample data for waveform digitizing in which a signal waveform representing a detected ToF measurement signal is generated from the digital ToF signal sample obtained through embodiments of threshold-based sampling.

Examples of ToF measurement systems may implement (e.g., as part of a sample processing circuit configured to apply one or more curve fitting techniques) one or more curve fitting hardware accelerators. For example, a signal waveform representing a detected ToF measurement signal may be generated at least in part by a curve fitting hardware accelerator of embodiments of the present invention. A curve fitting hardware accelerator may, for example, be configured to implement non-linear curve fitting techniques and/or linear curve fitting techniques. Such curve fitting hardware accelerators may comprise field programmable gate arrays (FPGAs), application specific integrated circuits (ASICs), and/or other hardware specifically configured for implementing curve fitting in accordance with concepts herein.

In operation according to embodiments of the invention, linear curve fitting applied by a curve fitting hardware accelerator may achieve high throughput and provide high accuracy signal waveform generation with respect to detected ToF measurement signals having particular characteristics (e.g., narrow pulse width, Gaussian distribution, etc.). Non linear curve fitting applied by a curve fitting hardware accelerator of embodiments may perform parallel processing of iterations of instances of the digital ToF signal sample data being processed to achieve higher throughput with respect to detected ToF measurement signals for which non-linear curve fitting is applied (e.g., characteristics of the signal, such as wide pulse width, non-Gaussian distribution, etc., are not well suited for linear curve fitting).

Examples of ToF measurement systems may implement (e.g., as part of a sample processing circuit) one or more multi-point filtering component. For example, multi-point filtering may be implemented according to some embodiments (e.g., based on simple averaging, Gaussian filter, etc.) to increase the signal-to-noise ratio (SNR) with respect to digital ToF signal sample data of a detected ToF measurement signal. Embodiments of ToF measurement systems may implement one or more multi-point filtering hardware accelerators to speed up range measurement speed. Such multi-point filtering hardware accelerators may comprise FPGAs, ASICs, and/or other hardware specifically configured for implementing multi-point filtering in accordance with concepts herein.

It can be appreciated from the foregoing that a ToF distance measurement system of embodiments of the invention may comprise a sampling circuit having a signal detector in communication with one or more TDCs. The signal detector of embodiments may be configured to detect a ToF measurement signal and provide a detected ToF measurement signal to the one or more TDCs. The one or more TDCs may be configured to apply a plurality of thresholds and output digital ToF signal sample data for a plurality of threshold-based samples of the detected ToF measurement signal. The ToF distance measurement system of embodiments may thus comprise a sample processing circuit in data communication with the sampling circuit. The sample processing circuit of embodiments may have one or more curve fitting hardware accelerators and ToF-based distance computation logic. The one or more curve fitting hardware accelerators may be configured to apply one or more curve fitting techniques to the digital ToF signal sample data and generate a signal waveform representing the detected ToF measurement signal. The distance computation logic may be configured to determine a ToF distance measurement based on the signal waveform representing the detected ToF measurement signal.

Additionally or alternatively, the ToF distance measurement system of embodiments may comprise one or more other components, circuits, devices, etc. for implementing ToF distance measurement. For example, the ToF distance measurement system may comprise a light source, a beam steerer, a multi-point filter, etc. A light source of a ToF distance measurement system may be configured to generate laser pulses of a ToF measurement signal which may be detected by a receiver of the signal detector configured to detect a laser pulse generated by the light source and reflected by a target of the ToF distance measurement. A beam steerer of a ToF distance measurement system may be configured to operate under control of a beam steering controller to direct laser pulses generated by a light source as ToF distance measurement signals for illuminating a target of ToF distance measurement. A multi-point filter (e.g., provided in or as a denoise circuit) of a ToF distance measurement system may be configured to increase SNR with respect to digital ToF signal sample data used to generate a signal waveform representing a detected ToF measurement signal.

ToF measurement techniques in accordance with concepts herein may be utilized in a variety of applications ranging from near range applications (e.g., augmented reality (AR) and virtual reality (VR)) to long-range applications (e.g., automotive light detection and ranging (LiDAR) and terrestrial laser scanner (TLS)). For example, ToF measurement techniques of the present invention may be implemented in three-dimensional (3D) sensing systems, such as those of TLS, automotive advanced driver assistance systems (ADAS), autonomous driving systems, autonomous ground vehicle (AGV) systems, building information modeling (BIM), security and surveillance, smart city infrastructure, logistic automation systems, AR/VR, etc.

The foregoing has outlined rather broadly the features and technical advantages of the present disclosure in order that the detailed description that follows may be better understood. Additional features and advantages will be described hereinafter which form the subject of the claims herein. It should be appreciated by those skilled in the art that the conception and specific embodiments disclosed may be readily utilized as a basis for modifying or designing other structures for carrying out the same purposes of the present designs. It should also be realized by those skilled in the art that such equivalent constructions do not depart from the spirit and scope as set forth in the appended claims. The novel features which are believed to be characteristic of the designs disclosed herein, both as to the organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawing, in which:

FIG. 1 illustrates threshold-based sampling of a detected time-of-flight (ToF) measurement signal according to embodiments of the present invention;

FIG. 2 illustrates curve fitting as may be implemented by a waveform reconstruction algorithm according to embodiments of the present invention;

FIG. 3 shows a functional block diagram providing threshold-based sampling and waveform digitizing according to embodiments of the present invention;

FIGS. 4A and 4B show examples of linear curve fitting applied by a waveform reconstruction algorithm according to embodiments of the present invention;

FIG. 5 shows an example iteration of non-linear curve fitting applied by a waveform reconstruction algorithm according to embodiments of the present invention;

FIG. 6 shows an example ToF distance measurement system configured to implement threshold-based sampling for waveform digitizing according to embodiments of the present invention;

FIG. 7 illustrates implementation of a multiple-processing core providing pipeline processing of curve fitting iterations according to embodiments of the present invention; and

FIG. 8 shows an example flow diagram providing operation of a ToF measurement system implementing threshold-based sampling for waveform digitizing according to embodiments of the present invention.

### DETAILED DESCRIPTION OF THE INVENTION

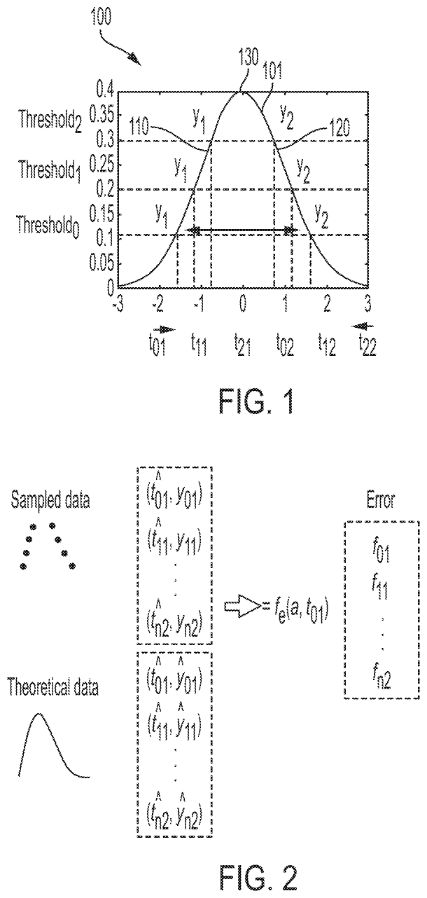

Time of flight (ToF) measurement techniques according to embodiments of the present invention implement threshold-based sampling for waveform digitizing to generate a signal waveform representing a detected ToF measurement signal from which a ToF distance measurement is determinable. For example, as shown in FIG. 1, a plurality of thresholds may be utilized for sampling a detected ToF measurement signal, such as may be detected as a received pulse reflected by a target for which distance is being measured. In graph 100 of the example of FIG. 1, Threshold₀, Threshold₁, and Threshold₂ are shown for use in ToF measurement with respect to detected ToF measurement signal 101. Threshold₀, Threshold₁, and Threshold₂ of the example comprise voltage thresholds, wherein a point (yₙₘ) at which an amplitude of detected ToF measurement signal 101 crosses a threshold corresponds to a time (tₙₘ).

It should be appreciated that the 3 thresholds shown in FIG. 1 are exemplary and are not intended to be limiting with respect to concepts of the present invention. Embodiments of ToF measurement techniques implemented in accordance with concepts described herein may include more or fewer thresholds. The number of thresholds utilized according to ToF measurement techniques of embodiments may, for example, depend on a particular pulse waveform utilized for ToF distance measurement. For example, if the pulse follows Gaussian distribution, at least one threshold may be utilized to sample both rising and falling edge of the waveform and at least two thresholds may be utilized to provide sample points from which to reconstruct the waveform in accordance with some embodiments. According to an example in which the rising edge of a very narrow pulse is sampled and processed using linear fitting, at least two thresholds may be utilized according to some embodiments. It should be appreciated that the use of more thresholds according to some embodiments may result in better waveform reconstruction accuracy. However, setting more thresholds will increase the complexity of sampling circuit design, and thus embodiments implement a balance between the number of thresholds utilized and circuit complexity for providing desired accuracy with respect to ToF measurements.

Thresholds utilized according to embodiments of the invention may be variously provided with respect to signal amplitude. For example, thresholds may comprise uniformly spaced magnitudes or may comprise magnitudes which are non-uniformly spaced. In accordance with some embodiments, a plurality of thresholds utilized for sampling a detected ToF measurement signal may comprise a lower threshold to facilitate sampling of a weak signal, and also a threshold close to maximum amplitude to facilitate covering the full range of a strong signal.

Detected ToF measurement signal 101 of the example illustrated in FIG. 1 comprises a received pulse (e.g., detected short pulse of light, such as may be a few nanoseconds in duration). Accordingly, detected ToF measurement signal 101 is shown as a pulse waveform comprising rising edge 110 and falling edge 120 which come together at peak 130.

ToF measurement techniques of embodiments of the invention may utilize a plurality of thresholds for sampling rising edge 110 and/or falling edge 120. The thresholds of the example illustrated in FIG. 1 are utilized for sampling both rising edge 110 and falling edge 120 of detected ToF measurement signal 101. Accordingly, the sample data includes a first plurality of data points for rising edge 110 of detected ToF measurement signal 101, shown as y₀₁, y₁₁, and y₂₁ (e.g., y₀₁=(Threshold_{0,t01}),y₁₁=(Threshold_{1,t11}), and y₂₁=(Threshold_{2,t21})). The sample data also includes a corresponding second plurality of data points for falling edge 120 of detected ToF measurement signal 101, shown as y₀₂, y₁₂, and y₂₂ (e.g., y₀₂=(Threshold_{0,t02}), y₁₂=(Threshold_{1,t12}), and y₂₂=(Threshold_{2,t22})).

As can be seen in graph 100 of FIG. 1, sample data provided by threshold-based sampling according to the illustrated example does not provide for a fixed sampling frequency (e.g., tot, t₁₁, t₂₁, t₀₂, t₁₂, and t₂₂ are not evenly spaced along the time axis). Accordingly, embodiments of the invention implement further processing with respect to the sample data for providing waveform digitizing in which a signal waveform representing detected ToF measurement signal 101 is generated. For example, a waveform reconstruction algorithm implemented according to embodiments of the invention may utilize curve fitting, as illustrated by FIG. 2. One or more curve fitting technique may be utilized according to example waveform reconstruction algorithms of embodiments. In accordance with some examples, linear curve fitting may be implemented by a waveform reconstruction algorithm to generate a signal waveform representing detected ToF measurement signal 101 from sample data provided by threshold-based sampling according to concepts herein. Additionally or alternatively, non-linear curve fitting may be implemented by a waveform reconstruction algorithm to generate a signal waveform representing detected ToF measurement signal 101 from sample data provided by threshold-based sampling according to concepts herein.

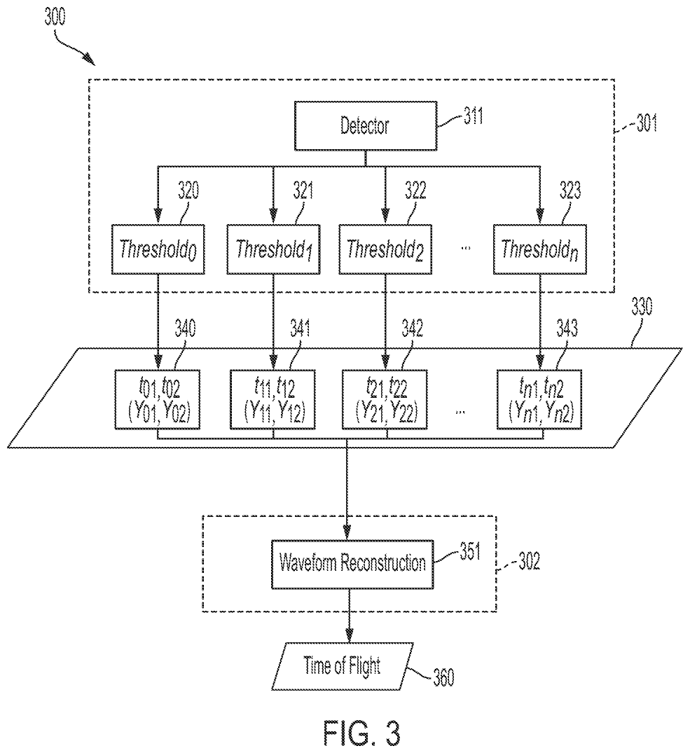

FIG. 3 shows functional block diagram 300 providing threshold-based sampling and waveform digitizing as described above. In particular, sampling block 301 of FIG. 3 implements functionality for threshold-based sampling to provide digital ToF signal sample data 330 utilized by functionality implemented by sample processing block 302 to generate time of flight data 360.

In operation according to functional block diagram 300, a received pulse (e.g., a ToF measurement laser light pulse as reflected by a target for which distance is being measured) may be detected by detector 311 and provided as a detected ToF measurement signal (e.g., detected ToF measurement signal 101 of FIG. 1) at sampling block 301. Thresholds 320-323 (e.g., Threshold₀, Threshold₁, Threshold₂, through Thresholdₙ) are applied to the detected ToF measurement signal at sampling block 301 to generate digital ToF signal sample data 330 for a plurality of threshold-based samples of the received pulse. For example, sample data 340 may be generated with respect to threshold 320 (e.g., y₀₁=(Threshold_{0,t01}) and y₀₂=(Threshold_{0,t02})), sample data 341 may be generated with respect to threshold 321 (e.g., y₁₁=(Threshold_{1,t11}) and y₁₂=(Threshold_{1,t12})), sample data 342 may be generated with respect to threshold 322 (e.g., y₂₁=(Threshold_{2,t21}) and y₂₂=(Threshold_{2,t22})), and sample data 343 may be generated with respect to threshold 323 (e.g., yₙ₁=(Threshold_{n,tn1}) and yₙ₂=(Threshold_{n,tn2})).

At sample processing block 302, waveform reconstruction algorithm 351 is applied with respect to digital ToF signal sample data 330 to generate time of flight data 360. For example, waveform reconstruction algorithm 351 may apply one or more curve fitting techniques to digital ToF signal sample data 330 for waveform digitizing of the received pulse. In operation according to embodiments of the invention, waveform reconstruction algorithm 351 may implement a selected curve fitting technique, such as based upon one or more characteristic of the detected ToF measurement signal and/or the digital ToF signal sample data generated therefrom (e.g., pulse width, pulse shape, waveform distribution, etc.). Curve fitting techniques as implemented according to embodiments of the invention reconstructs a complete detected ToF sample signal waveform from sampled points, to facilitate high-resolution and high-accuracy TOF measurement.

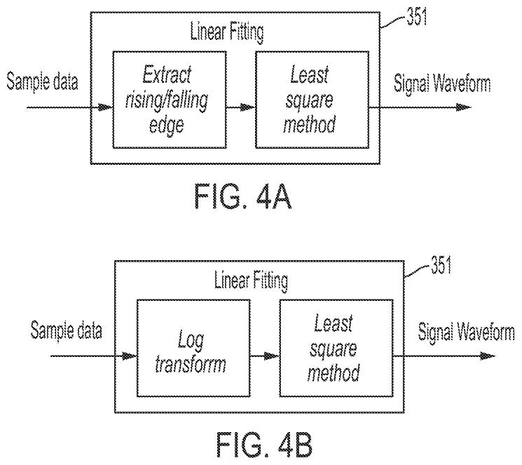

According to some examples, waveform reconstruction algorithm 351 may apply linear curve fitting. As illustrated in FIGS. 4A and 4B, linear curve fitting techniques implemented by waveform reconstruction algorithm 351 may apply least squares fitting to find a best fitting curve for data points of digital ToF signal sample data 330. For example, linear curve fitting using least squares fitting may be applied according to embodiments in situations where the detected ToF measurement signal has a narrow pulse width (e.g., 1 ns). As illustrated in FIG. 4A, for situations in which the detected ToF measurement signal has a narrow pulse width (e.g., fast rising edge and/or fast falling edge), the digital ToF signal sample data for the rising edge and/or falling edge of the detected ToF measurement signal may be extracted and least squares fitting applied to generate a signal waveform representing the detected ToF measurement signal or some portion thereof. According to another example, linear curve fitting using least squares fitting may be applied according to embodiments in situations where the detected ToF measurement signal (e.g., digital ToF signal sample data 330) has a Gaussian distribution. As illustrated in FIG. 4B, for situations in which the detected ToF measurement signal has a Gaussian distribution, log transformation may be applied to digital ToF signal sample data 330 and least squares fitting applied to generate a signal waveform representing the detected ToF measurement signal or some portion thereof.

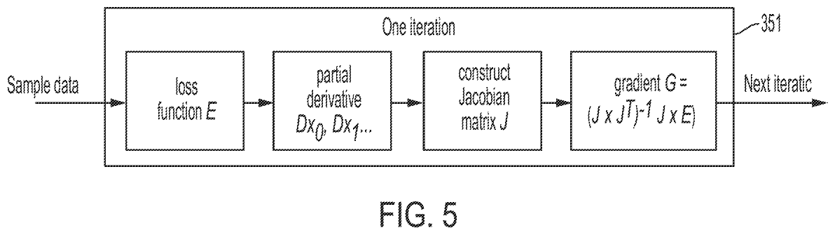

Additionally or alternatively, waveform reconstruction algorithm 351 of some examples may apply non-linear curve fitting techniques. As illustrated in FIG. 5, non linear curve fitting techniques implemented by waveform reconstruction algorithm 351 may apply Gauss-Newton fitting to find a best fitting curve for data points of digital ToF signal sample data 330. For example, non-linear curve fitting using Gauss-Newton fitting may be applied according to embodiments to solve non-linear least squares problems in situations for which linear curve fitting is not well suited (e.g., characteristics of the signal, such as wide pulse width, non-Gaussian distribution, etc., are not well suited for linear curve fitting). According to some embodiments, non-linear curve fitting using Gauss-Newton fitting may be applied for any pulse shape, including those for which linear curve fitting techniques may be applied. Gauss-Newton fitting implemented by embodiments of waveform reconstruction algorithm 351 iteratively solves non-linear least squares problems using a series of calculations to find the solution. FIG. 5 shows a single iteration of an implementation of the Gauss-Newton fitting technique, wherein multiple (e.g., 3-5) iterations of the computations shown in waveform reconstruction algorithm 351 of FIG. 5 may be applied to digital ToF signal sample data 330 to generate a signal waveform representing the detected ToF measurement signal or some portion thereof.

Irrespective of the particular curve fitting technique or techniques (e.g., linear curve fitting and/or non-linear curve fitting) applied by waveform reconstruction algorithm 315, operation according to functional block diagram 300 of FIG. 3 generates time of flight data 360. Time of flight data 360 may (e.g., depending upon the particular functionality implemented by sample processing block 302) comprise a signal waveform representing the detected ToF measurement signal (e.g., detected ToF measurement signal 101), or some portion thereof (e.g., rising edge, falling edge, peak, etc.), from which a ToF distance measurement is determinable. For example, further signal processing may be provided with respect to a digitized waveform of time of flight data 360 to compare time aspects (e.g., signal or pulse peak, start point of the pulse, etc.) of the originally emitted ToF measurement pulse and digitized waveform of the detected ToF measurement signal to determine a distance to a target (e.g., d=(ct)/2). Additionally or alternatively, time of flight data 360 may comprise information regarding a distance to a target (e.g., a magnitude of the roundtrip time of the ToF measurement signal from an emitter to the detector, such as may be determined by functionality implemented by sample processing block 302 comparing time aspects of the originally emitted ToF measurement pulse and digitized waveform of the detected ToF measurement signal).

ToF measurement techniques implementing threshold-based sampling for waveform digitizing according to embodiments of the present invention may be utilized in, or in association with, various configurations of ToF distance measurement systems. For example, ToF measurement techniques in accordance with the example of functional block diagram 300 may be implemented in ToF distance measurement systems configured for three-dimensional (3D) sensing (e.g., terrestrial laser scanner (TLS) systems, automotive advanced driver assistance systems (ADAS), autonomous driving systems, autonomous ground vehicle (AGV) systems, building information modeling (BIM) systems, security and surveillance systems, smart city systems, logistic automation systems, AR/VR systems, etc.).

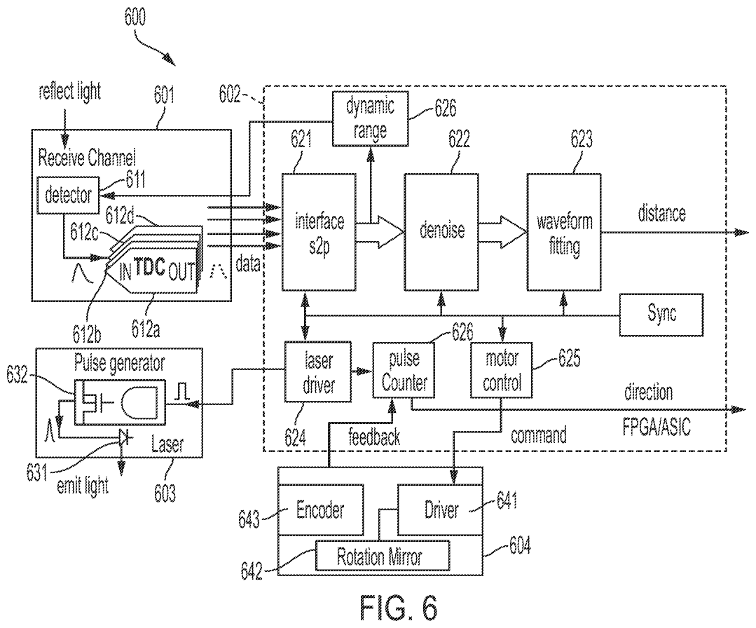

FIG. 6 shows an example ToF distance measurement system configured to utilize ToF measurement techniques implementing threshold-based sampling for waveform digitizing according to embodiments of the present invention. In particular, ToF distance measurement system 600 of FIG. 6 includes sampling circuit 601 configured to provide functionality corresponding to that sampling block 301 functional block diagram 300 and sample processing circuit 602 configured to provide functionality corresponding to that of sample processing block 302 of functional block diagram 300. It should be appreciated that ToF distance measurement system 600 of the illustrated example also includes other componentry for implementing ToF distance measurement. For example, ToF distance measurement system 600 is shown to include light source 603 and beam steerer 604 operable in cooperation with sampling circuit 601 and sample processing circuit 602 for providing ToF distance measurement. It should further be appreciated that a ToF distance measurement system configured to utilize ToF measurement techniques implementing threshold-based sampling for waveform digitizing according to embodiments of the present invention may comprise components, circuits, devices, etc. in addition or alternative to those of ToF distance measurement system 600 of the illustrated example.

Sampling circuit 601 of the embodiment of ToF distance measurement system 600 illustrated in FIG. 6 comprises detector 611 in communication with a plurality of time-to-digital converters (TDCs), shown as TDCs 612a-612d. Detector 611 of embodiments may comprise a photodetector (PD), avalanche photodiode (APD) detector, single-photon avalanche diode (SPAD) detector, silicon photomultiplier (SiPM) detector, or other detector implementation configured to detect light emitted by light source 603 as reflected from a target of ToF distance measurement. In operation according to embodiments, detector 611 detects a ToF distance measurement signal (e.g., laser pulse emitted by light source 603 and from a target) and outputs a detected ToF measurement signal waveform (e.g., time domain waveform). The detected ToF measurement signal provided to TDCs 612a-612d in operation of ToF distance measurement system 600.

The TDCs of embodiments of sampling circuit 601 are configured to apply a plurality of thresholds and output digital ToF signal sample data for a plurality of threshold-based samples of the detected ToF measurement signal. The plurality of thresholds may, for example, comprise voltage thresholds. Each TDC of TDCs 612a-612d may be configured to implement a different threshold of a plurality of thresholds (e.g., TDC 612a applying Threshold₀, TDC 612b applying Threshold₁, TDC 612c applying Threshold₂, . . . and TDC 612d applying Thresholdₙ) to sample the detected ToF measurement signal (e.g., rising edge and/or falling edge) provided by detector 611. According to some embodiments, each TDC may be configured to implement a respective threshold for both the rising and falling edges of the detected ToF measurement signal. In accordance with further embodiments, a TDC may be configured to implement a particular threshold with respect to the rising edge of the detected ToF measurement signal and a corresponding TDC may implement that particular threshold with respect to the falling edge of the detected ToF measurement signal. In still further embodiments, a TDC may be configured to implement a plurality of thresholds with respect to the detected ToF measurement signal (e.g., for the rising edge and/or falling edge).

In operation according to embodiments of ToF distance measurement system 600, TDCs 612a-612d implement threshold-based sampling in which times at which the detected ToF measurement signal crosses each of the plurality of thresholds are detected and corresponding digital ToF signal sample data is output (e.g., digital ToF signal sample data 330 of FIG. 3). It should be appreciated that digital ToF signal sample data provided by sampling circuit 601 may comprise time data for each threshold crossing (e.g., t₀₁, t₁₁, t₂₁, t₀₂, t₁₂, t₂₂, . . . tₙₘ), data points for a rising edge of the detected ToF measurement signal (e.g., y₀₁, y₁₁, y₂₁, . . . yₙ₁) and/or a falling edge of the detected ToF measurement signal (e.g., y₀₂, y₁₂, y₂₂, . . . vₙ₂), and/or threshold data (e.g., Threshold₀, Threshold₁, Threshold₂, . . . Thresholdₙ). In accordance with some examples, sampling circuit 601 provides time data for each threshold crossing (e.g., t₀₁, t₁₁, t₂₁, t₀₂, t₁₂, t₂₂, . . . tₙₘ) with respect to detected ToF distance measurement signals, wherein preconfigured or otherwise pre-known threshold data (e.g., Threshold₀, Threshold₁, Threshold₂, Thresholdₙ) may be utilized by logic of sample processing circuit 602 to determine the data points for a rising edge and/or falling edge of the detected ToF measurement signals (e.g., y₀₁=(Threshold_{0,t01}), v₁₁=(Threshold_{1,t11}),y₂₁=(Threshold_{2,t12}), . . . yₙ₁=(Threshold_{n,tn1}), and y₀₂ (Threshold_{0,t02}), y₁₂=(Threshold_{1,t12}), y₂₂−(Threshold_{2,t22}) . . . yₙ₂=(Threshold_{n,tn2})).

Sample processing circuit 602 of the illustrated embodiment is provided in data communication with sampling circuit 601. In operation according to embodiments of the invention, sample processing circuit 602 is configured to received digital ToF signal sample data output by sampling circuit 601 and implement waveform digitizing functionality to generate a signal waveform representing the detected ToF measurement signal from which a ToF distance measurement is determinable. Accordingly, sample processing circuit 602 of the embodiment of ToF distance measurement system 600 illustrated in FIG. 6 includes interface 621 in communication with sampling circuit 601. Sample processing circuit 602 of the illustrated embodiment further includes denoise circuit 622 and waveform fitting circuit 623 configured to implement processing with respect to the digital ToF signal sample data for waveform digitizing.

Interface 621 of embodiments of sample processing circuit 602 is configured to receive digital ToF signal sample data in a form provided by sampling circuit 601 and provide that data to circuitry of sample processing circuit 602 for waveform digitizing processing. For example, digital ToF signal sample data may be provided as serial data by TDCs 612a-612d of sampling circuit 601, wherein interface 621 may provide serial-to-parallel conversion of the digital ToF signal sample data for processing by various circuitry (e.g., sampling circuit 601 and denoise circuit 622) of sample processing circuit 602.

Denoise circuit 622 of embodiments of sample processing circuit 602 is configured to provide processing with respect to the digital ToF signal sample data for reducing or mitigating noise (e.g., increase the signal-to-noise ratio (SNR), filter noise, etc.). For example, denoise circuit 622 may be configured to implement multi-point filtering (e.g., based on simple averaging, Gaussian filter, etc.) to increase the SNR with respect to the digital ToF signal sample data of detected ToF measurement signals.

According to embodiments of the present invention, denoise circuit 622 may be implemented using one or more multi-point filtering hardware accelerators to speed up range measurement speed. Such multi-point filtering hardware accelerators may comprise field programmable gate arrays (FPGAs), application specific integrated circuits (ASICs), and/or other hardware specifically configured for implementing multi-point filtering (e.g., multi-point filtering based on simple averaging, Gaussian filter, etc. to increase SNR) in accordance with concepts herein. For example, multi-point filtering circuitry of denoise circuit 622, denoise circuit 622 itself, and/or sample processing circuit 602 may be provided in a FPGA or ASIC implementation having circuitry specifically configured for implementing multi-point filtering with respect to the digital ToF signal sample data.

Waveform fitting circuit 623 of embodiments of sample processing circuit 602 is configured to provide processing with respect to the digital ToF signal sample data for waveform digitizing to generate a signal waveform representing the detected ToF measurement signal. For example, waveform fitting circuit 623 may be configured to implement curve fitting (e.g., using waveform reconstruction algorithm 351 of FIG. 3) with respect to the digital ToF signal sample data for waveform digitizing of the detected ToF measurement signal. Curve fitting techniques applied by waveform fitting circuit 623 may, for example, implement linear curve fitting and/or non-linear curve fitting, such as depending upon characteristics of the detected ToF measurement signal and/or other aspects of a situation in which a ToF measurement is made. According to some examples, digital ToF signal sample data provided by particular implementations of sampling circuit 601 (e.g., using embodiments of detector 611 comprising a SPAD or SiPM detector) may be well suited for application of non-linear curve fitting by waveform fitting circuit 623. Similarly, digital ToF signal sample data provided by other particular implementations of sampling circuit 601 (e.g., using embodiments of detector 611 comprising a PD or APD detector) may be well suited for application of linear curve fitting by waveform fitting circuit 623.

According to embodiments of the present invention, waveform fitting circuit 623 may be implemented using one or more curve fitting hardware accelerators to speed up range measurement speed. Such curve fitting hardware accelerators may be implemented on FPGAs, ASICs, and/or other hardware specifically configured for processing curve fitting (e.g., curve fitting functionality as described above with respect to FIGS. 4A, 4B, and/or 5) in accordance with concepts herein. For example, curve fitting circuitry of waveform fitting circuit 623, waveform fitting circuit 623 itself, and/or sample processing circuit 602 may be provided in a FPGA or ASIC implementation having circuitry specifically configured for implementing curve fitting with respect to the digital ToF signal sample data.

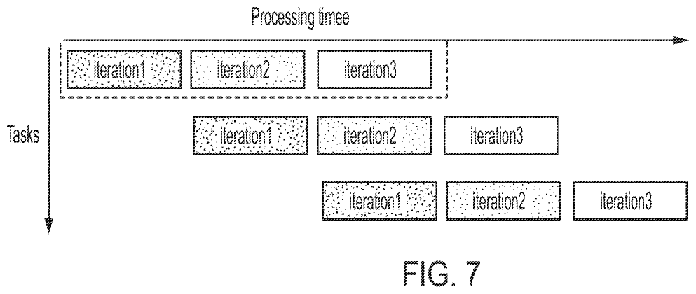

Waveform fitting circuit 623 of embodiments may be configured to apply non-linear curve fitting using Gauss-Newton fitting which, as described above with reference to FIG. 5, provides an iterative solution. Accordingly, curve fitting hardware accelerators of embodiments of sample processing circuit 602 may utilize parallelism of hardware to accelerate processing. FIG. 7 illustrates implementation of a processing core comprising a 3-iteration pipeline (e.g., 3 iterations of the Gauss-Newton fitting technique iteration shown in FIG. 5). Embodiments utilizing a multi-core device (e.g., FPGA device with the requisite hardware resources) may provide implementations of a processing core with more iterations to increase fitting accuracy and/or more processing cores to achieve higher throughput. Multiple-processing core implementations of curve fitting hardware accelerators of embodiments of the invention achieve higher throughput (e.g., greater than 500 K/s for one 3-iteration processing core) than implementations processing each iteration individually without benefit of pipeline processing.

Signal waveforms representing detected ToF measurement signals may be output (e.g., as time of flight data 360) by waveform fitting circuit 623 of embodiments of sample processing circuit 602. For example, ToF-based distance computation logic may be provided in communication with sample processing circuit 602, whereby further signal processing may be provided with respect to a digitized waveform of a signal waveform representing a detected ToF measurement signal to determine a distance to a target. According to the illustrated embodiment of ToF distance measurement system 600, in addition to providing functionality (e.g., curve fitting as described above) for processing the digital ToF signal sample data for waveform digitizing, sample processing circuit 602 comprises ToF-based distance computation logic. For example, waveform fitting circuit 623 may include distance computation logic configured to determine a ToF distance measurement based on the signal waveform representing the detected ToF measurement signal. Distance computation logic of embodiments of sample processing circuit 602 may, for example, operate to compare one or more aspects of the originally emitted ToF measurement pulse and digitized waveform of the detected ToF measurement signal to determine a distance to a target and output that information as distance data.

Light source 603 of the embodiment of ToF distance measurement system 600 illustrated in FIG. 6 comprises laser light emitter 631 configured to emit laser light of a ToF measurement signal. Laser light emitter 631 may, for example, operate in response to pulse generator circuit 632 (e.g., under control of laser driver circuit 624 of sample processing circuit 602) to generate laser pulses of a ToF measurement signal configured for detecting by detector 611 of sampling circuit 601.

The illustrated embodiment of ToF distance measurement system 600 is configured to facilitate 3D sensing within a volume or area of interest. Accordingly, ToF distance measurement system 600 is shown to include a beam steering component operable with respect to light emitted by light source 603. Beam steerer 604 of the illustrated embodiment is configured to operate under control of motor control 625 of sample processing circuit 602 (e.g., using a control feedback loop provided by encoder 643 and pulse counter 626) to direct laser pulses generated by laser light emitter 631 as ToF distance measurement signals for illuminating a target within an area of interest for ToF distance measurement. For example, driver 641 may be controlled by motor control 625 to spin a motor of rotation mirror 642 so that laser light pulses emitted by laser light emitter 631 are scanned throughout the area of interest. According to some examples, micro-electro-mechanical systems (MEMS) mirror configurations may be utilized as rotation mirror 642 (e.g., in addition to or in the alternative to implementations of rotation of a mirror by a motor) to provide scanning of laser light pulses for ToF distance measurements. Direction information with respect to the scanning of the laser light pulses may be provided in association with time of flight data by sample processing circuit 602 so that both direction and distance are known (e.g., for use in generating a 3D point cloud or other representation of the target and/or area of interest).

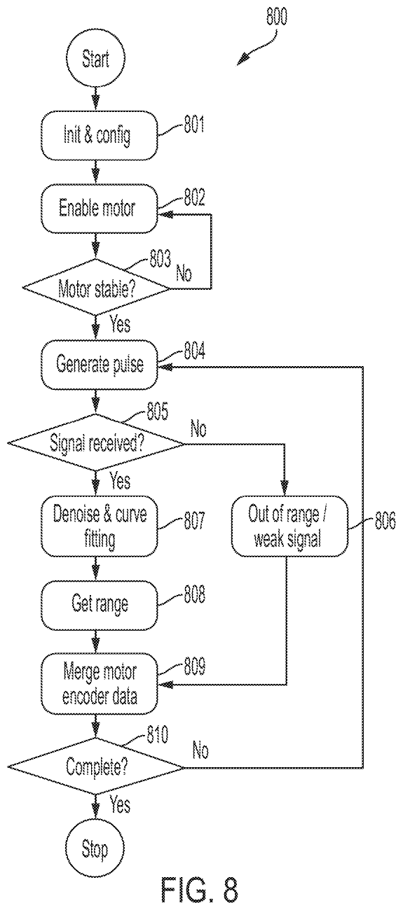

Having described an example of ToF distance measurement system 600 as illustrated in FIG. 6, attention is directed to FIG. 8 wherein operation of embodiments of ToF distance measurement system 600 is shown. In particular, flow 800 of FIG. 8 illustrates example operation of an embodiment of ToF distance measurement system 600 utilizing ToF measurement techniques implementing threshold-based sampling for waveform digitizing.

Upon starting flow 800 of the illustrated embodiment, initialization and configuration with respect to ToF distance measurement system 600 is performed at block 801. For example, threshold values for a plurality of thresholds utilized with one or more TDCs of sampling circuit 601 may be configured. Additionally, one or more predefined pulse shape of ToF measurement pulses to be emitted by light source 603 (e.g., for use in comparing one or more aspects to digitized waveforms of detected ToF measurement signals for determining distances to a targets) may be configured.

At block 802 of flow 800, a motor of rotation mirror 642 is enabled. For example, motor control 625 and driver 641 may cooperate to control the motor to spin a mirror surface of rotation mirror 642 at a controlled speed for scanning an area and/or target of interest. Correspondingly, determination is made at block 803 regarding whether the motor is stable. If, for example, the rotational speed of the mirror surface has not reached steady-state, processing may return to block 802 to facilitate the motor speed of rotation mirror 642 reaching steady-state. However, if the rotational speed of the mirror surface has reached steady-state, processing may proceed to block 804 for ToF measurement operation.

A laser pulse for ToF measurement is generated at block 804 of the example of flow 800. For example, a laser pulse of a ToF measurement signal configured for detecting by detector 611 of sampling circuit 601 may be emitted by laser light emitter 631 in response to pulse generator circuit 632 operating under control of laser driver circuit 624 of sample processing circuit 602. In operation according to some examples, pulse generator circuit 632 may cause laser light emitter 631 to generate narrow laser pulses (e.g., having pulse widths less than 5 ns, some examples having sub-nanosecond pulse widths), such as to increase the SNR with respect to a detected ToF measurement signal.

At block 805 of the illustrated example, a determination is made regarding whether a signal is received (or adequately received for ToF measurement processing) in correspondence to the generated pulse. For example, logic of dynamic range control 627 may analyze data points (e.g., presence/non-presence of data points, distribution of data points, etc.) provided by sampling circuit 601 with respect to a ToF measurement signal as detected by detector 611 to determine if an adequate signal has been received (e.g., data provided by sampling circuit 601 indicates that one or more aspects of a detected signal are out of range, the detected signal is a weak signal insufficient for reliable ToF measurement processing, etc.). If, for example, it is determined that an adequate signal has not been received at block 805, processing according to the illustrated example proceeds to block 806 to implement out of range/weak signal processing (e.g., implement dynamic range control with respect to detector 611, initiate control with respect to light source 603 and/or beam steerer 604 to facilitate detecting of a ToF measurement signal, etc.) Thereafter, processing may proceed to block 809 to proceed according to flow 800 as described below. If, however, it is determined that an adequate signal has been received at block 805 processing according to the illustrated example of flow 800 proceeds to block 807 for processing with respect to the digital ToF signal sample data of the detected ToF measurement signal.

Processing with respect to the digital ToF signal sample data of a detected ToF measurement signal at block 807 of embodiments of flow 800 includes processing for reducing or mitigating noise (e.g., operation of denoise circuit 622) and processing for waveform digitizing to generate a signal waveform representing the detected ToF measurement signal (e.g., operation of waveform fitting circuit 623). For example, denoise circuit 622 may implement multi-point filtering with respect to the digital ToF signal sample data, as described above, at block 807. Further, waveform fitting circuit 623 may implement curve fitting (e.g., implement linear curve fitting and/or non-linear curve fitting of waveform reconstruction algorithm 351), as described above, at block 807.

At block 807, a range (e.g., distance) to a target is obtained using the generated signal waveform representing the detected ToF measurement signal. For example, include distance computation logic of waveform fitting circuit 623 may operate to determine a ToF distance measurement based on the signal waveform representing the detected ToF measurement signal.

Motor encoder data is merged at block 809 of the illustrated embodiment of flow 800. For example, ToF measurement may provide distance information according to aspects of the disclosure. Information regarding the emitting direction of the ToF measurement signal pulse may be utilized to facilitate generation of a 3D point cloud. Motor encoder data of embodiments provides a beam steering angle corresponding to the emitting direction of the ToF measurement signal pulse. In operation at block 809 of embodiments, motor encoder data is merged with ToF distance measurement information for generating a 3D point cloud (e.g., by mapping ToF distance and corresponding beam steering angle).

At block 810, a determination is made with respect to whether operation of ToF distance measurement system 600 implementing threshold-based sampling for waveform digitizing is complete. For example, a determination may be made as to whether a scan of a target or area of interest has been completed. If it is determined at block 810 that operation is not complete, processing according to the illustrated embodiment returns to block 804 for generation of a next laser pulse for ToF measurement. If, however, it is determined at block 810 that operation is complete, processing according to the example of flow 800 stops.

Although the present disclosure and its advantages have been described in detail, it should be understood that various changes, substitutions and alterations can be made herein without departing from the spirit and scope of the design as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

Moreover, the scope of the present application is not intended to be limited to the particular embodiments of the process, machine, manufacture, composition of matter, means, methods and steps described in the specification.

What is claimed is:

1. A system for use in time of flight (ToF) distance measurement, the system comprising:
a sampling circuit configured to detect a ToF measurement signal and provide digital ToF signal sample data for a plurality of threshold-based samples of a detected ToF measurement signal; and
a sample processing circuit in data communication with the sampling circuit and configured to apply one or more curve fitting techniques to the digital ToF signal sample data and generate a signal waveform representing the detected ToF measurement signal from which the ToF distance measurement is determinable.

2. The system of claim 1, wherein the digital ToF signal sample data includes a first plurality of data points for a rising edge of the detected ToF measurement signal as detected by the sampling circuit and a corresponding second plurality of data points for a falling edge of the detected ToF measurement signal as detected by the sampling circuit, and wherein the first plurality of data points and the corresponding second plurality of data points each comprise a data point of the digital ToF signal sample data for each threshold of the plurality of threshold-based samples of the detected ToF measurement signal.

3. The system of claim 1, wherein the sampling circuit comprises:
one or more time-to-digital converters (TDCs) configured to apply a plurality of thresholds for the plurality of threshold-based samples of the detected ToF measurement signal.

4. The system of claim 3, wherein the plurality of thresholds comprise voltage thresholds, and wherein the digital ToF signal sample data comprise time data with respect to the detected ToF measurement signal crossing each voltage threshold of the plurality of thresholds.

5. The system of claim 1, wherein the sample processing circuit comprises:
one or more curve fitting hardware accelerators, wherein the signal waveform representing the detected ToF measurement signal is generated at least in part by a curve fitting hardware accelerator of the one or more curve fitting hardware accelerators.

6. The system of claim 5, wherein the one or more curve fitting hardware accelerators are implemented on a field programmable gate array (FPGA) or an application specific integrated circuit (ASIC) configured to perform a curve fitting technique of the one or more curve fitting techniques.

7. The system of claim 5, wherein the one or more curve fitting techniques includes a linear curve fitting technique and a non-linear curve fitting technique, and wherein the one or more curve fitting hardware accelerators comprise:
a first curve fitting hardware accelerator configured to implement the linear curve fitting technique; and
a second curve fitting hardware accelerator configured to implement the non-linear curve fitting technique.

8. The system of claim 7, wherein the second curve fitting hardware accelerator comprises:
parallel processing circuitry configured to perform parallel processing of iterations of instances of the digital ToF signal sample data being processed by the sample processing circuit.

9. The system of claim 5, wherein the sample processing circuit further comprises:
a multi-point filter implementing a hardware accelerator and configured to increase a signal-to-noise ratio (SNR) with respect to the digital ToF signal sample data, wherein the hardware accelerator is implemented on a field programmable gate array (FPGA) or an application specific integrated circuit (ASIC) configured to perform multi-point filtering.

10. A method for use in time of flight (ToF) distance measurement, the method comprising:
sampling a plurality of threshold-based samples of a detected ToF measurement signal;
providing digital ToF signal sample data for the plurality of threshold-based samples of the detected ToF measurement signal; and
generating a signal waveform representing the detected ToF measurement signal by applying one or more curve fitting techniques to the digital ToF signal sample data.

11. The method of claim 10, wherein the digital ToF signal sample data includes a first plurality of data points for a rising edge of the detected ToF measurement signal as detected by a sampling circuit and a corresponding second plurality of data points for a falling edge of the detected ToF measurement signal as detected by the sampling circuit, and wherein the first plurality of data points and the corresponding second plurality of data points each comprise a data point of the digital ToF signal sample data for each threshold of the plurality of threshold-based samples of the detected ToF measurement signal.

12. The method of claim 10, wherein the sampling the plurality of threshold-based samples of the detected ToF measurement signal comprises:
applying, by one or more time-to-digital converters (TDCs), a plurality of thresholds for the plurality of threshold-based samples of the detected ToF measurement signal.

13. The method of claim 12, wherein the plurality of thresholds comprise voltage thresholds, and wherein the digital ToF signal sample data comprise time data with respect to the detected ToF measurement signal crossing each voltage threshold of the plurality of thresholds.

14. The method of claim 10, wherein the generating the signal waveform representing the detected ToF measurement signal comprises:
generating the signal waveform representing the detected ToF measurement signal, at least in part, using one or more curve fitting hardware accelerators.

15. The method of claim 14, wherein the one or more curve fitting hardware accelerators are implemented on a field programmable gate array (FPGA) or an application specific integrated circuit (ASIC) configured to perform a curve fitting technique of the one or more curve fitting techniques.

16. The method of claim 14, wherein the one or more curve fitting techniques includes a linear curve fitting technique and a non-linear curve fitting technique, and wherein the one or more curve fitting hardware accelerators comprise a first curve fitting hardware accelerator configured to implement the linear curve fitting technique and a second curve fitting hardware accelerator configured to implement the non-linear curve fitting technique.

17. The method of claim 16, wherein generating the signal waveform representing the detected ToF measurement signal, at least in part, using the second curve fitting hardware accelerator of the one or more curve fitting hardware accelerators comprises:
performing parallel processing of iterations of instances of the digital ToF signal sample data being processed.

18. The method of claim 10, further comprising:
filtering the digital ToF signal sample data using a multi-point filter configured to increase a signal-to-noise ratio (SNR) prior to the generating the signal waveform representing the detected ToF measurement signal.

19. A system for time of flight (ToF) distance measurement, the system comprising:
a sampling circuit having a signal detector in communication with one or more time-to-digital converters (TDCs), wherein the signal detector is configured to detect a ToF measurement signal and provide a detected ToF measurement signal to the one or more TDCs, wherein the one or more TDCs are configured to apply a plurality of thresholds and output digital ToF signal sample data for a plurality of threshold-based samples of the detected ToF measurement signal; and
a sample processing circuit in data communication with the sampling circuit and having one or more curve fitting hardware accelerators and ToF-based distance computation logic, wherein the one or more curve fitting hardware accelerators are configured to apply one or more curve fitting techniques to the digital ToF signal sample data and generate a signal waveform representing the detected ToF measurement signal, and wherein the ToF-based distance computation logic is configured to determine a ToF distance measurement based on the signal waveform representing the detected ToF measurement signal.

20. The system of claim 19, further comprising:
a light source configured to generate laser pulses, wherein the ToF measurement signal comprises a laser pulse generated by the light source, wherein the signal detector comprises a receiver configured to detect a laser pulse generated by the light source and reflected by a target of the ToF distance measurement;
a beam steerer configured to operate under control of a beam steering controller to direct laser pulses generated by the light source as ToF distance measurement signals for illuminating a target of the ToF distance measurement; and
a multi-point filter configured to increase a signal-to-noise ratio (SNR) with respect to the digital ToF signal sample data.
